(19) United States
(12) Patent Application Publication
(10) Pub. No.: US 2019/0003829 A1
(43) Pub. Date: Jan. 3, 2019

(54) Image processing apparatus and method for determining the volume of timber in a stack of logs

(71) Applicant: Timbeter OÜ, Tallinn (EE)

(72) Inventors: Martin Kambla, Rannamõisa küla, Harjumaa (EE); Tanel Sirp, Tallinn (EE)

(73) Assignee: Timbeter OÜ, Tallinn (EE)

(21) Appl. No.: 16/066,710

(22) PCT Filed: Jan. 2, 2017
(86) PCT No.: PCT/EP2017/050038

§ 371 Date: Jun. 28, 2018

Related U.S. Application Data
(60) Provisional application No. 62/272,191, filed on Dec. 29, 2015.

(51) Int. Cl. G01B 11/28; G01B 5/00; G01B 11/27; G01B 11/08

(52) U.S. Cl. CPC G01B 11/28; G01B 11/08; G01B 11/27; G01B 5/0035

(57) ABSTRACT

A system for determination of the volume of a stack of logs comprises digital image acquisition of a stack end with a known reference dimension, image display and image recognition for determination of the total volume of timber. Volume is determined by image analysis routines for detecting the end of each log in the digital image and overlying circles substantially coincident with each detected log end on the digital image. An operator may manually adjust or vary the circles on an interactive screen. The areas of each overlaid circle is calculated and total volume is determined factoring in a standardized log length and stratification data entered by the operator.

### FIELD OF THE INVENTION

This invention relates generally to timber processing of log stacks and more specifically to a system for detection of the total useful timber volume in a stack of logs and the stratification thereof.

### PRIOR ART OF THE INVENTION

Over the years various types of systems have been devised for measurement of timber for determination of the useful volume and stratification for processing logs into lumber or other wood based products or intermediaries, such as wood pulp. Among the systems has been volume approximation by weight measurement, for example. Among the variable factors involved with weight measurement were time duration since felling, species, log type, season.

Although weight measurement was a relatively inexpensive procedure, inaccuracies were encountered because of weight change between felling and weighing and weight measurement was generally employed with respect to low value timber.

A further system was premised upon stack measurement, i.e., measurement of the gross volume of timber and gaps between logs and calculation of the stack volume by application of a conversion factors for gap compensation. This system suffered due to the introduction of errors relating to the conversion factors and also did not adequately compensate for curved, bent or crooked logs.

The closest systems to the present invention has been described on Fovea webpage www.fovea.eu and on Trestima webpage https://www.trestima.com/products_en/#logpile. Fovea's system doesn't allow to measure diameters less than 10 cm and doesn't include adjustable reference size, it uses the width of the stack and automatically places the reference in the back-end. The Fovea's system doesn't allow to measure the end of the truck, because the reference size (˜2.5 meters) is not enough, the calculation formula of measuring the volume of timber is limited only by one predefined formula, instead of showing the diameter of the log, it is divided into diameter classes based upon the German standard. The Trestima's system for measuring timber is not functioning offline—meaning they need the server to give a response. If some of the logs are not recognized they use a statistical average to calculate the rest of the pile.

These deficiencies of Fovea's and Trestima's systems lead to high inaccuracies and set lots of limits for usability. Due to the said deficiencies it is not possible to measure timber quickly and accurately.

### BRIEF DESCRIPTION OF THE INVENTION

The aim of the present invention is to provide a system to measure timber and report stacked timber volume quickly, accurately and efficiently which would be fast and easy to use without need for double-entries, would provide a strong evidence of the existence of timber measured and enable to share data easily with all parties, creating a transparent and fair negotiation process.

The aim of the present invention is achieved by a system for determination of the volume of a stack of logs, which comprises digital image acquisition of a stack end with a known reference dimension, image display and image recognition for determination of the total volume of timber. Stack timber volume is determined by image analysis routines for detecting the end of each log in the digital image and overlying circles substantially coincident with each detected log end on the digital image. The system output comprises stack volume as well as stratification details entered by an operator. Among the image analysis routines are initial detection stages comprising a cascade detector routine and a candidate merge routine, filtering stages comprising a votes and radius filter routine, a cluster circle filter routine and a concentric filter routine and refining stages comprising an octagon routine and a pixelwise segmentation routine. Circles are overlaid on each log end in the digital image and an operator may manually adjust or vary the circles on an interactive screen. The areas of each overlaid circles is calculated and total volume is determined factoring in a standardized log length and stratification data entered by the operator.

From the foregoing compendium, it will be appreciated that an aspect of the present invention is to provide a system for timber quantification of the general character described which is not subject to the foregoing disadvantages of the antecedents of the invention.

A feature of the present invention is to provide a system for timber quantification of the general character described which is easy to use. A consideration of the present invention is to provide a system for timber quantification of the general character described with increased accuracy and efficiency.

A further aspect of the present invention is to provide a system for timber quantification of the general character described which is well adapted for onsite measurement of truckload log stacks as well as log stacks lying on the ground.

Another feature of the present invention is to provide a system for timber quantification of the general character described which provides digital image record of a log stack for both inventory and loss prevention purposes.

A further aspect of the present invention is to provide a system for timber quantification of the general character described which provides digital image record of a log stack for invoicing purposes.

A system for determination of the volume of a stack of logs comprises color digital imaging of the stack (taken on a vertical plane) including imaging a known referenced dimension and image recognition processing for determination of the total volume of timber in the stack.

Timber volume is determined, in one embodiment, (log-by-log) by detecting the end of each log in the stack or pile in an end view digital image, overlying circles substantially coincident with each detected log end on the digital image, calculating the area of each overlaid circle and factoring in the standardized log length.

In a second embodiment, points along the periphery of the stack or pile of logs are marked on a digital image comprising an end view, the points are joined or connected to enclose the stack within a peripheral border, the total area within the peripheral border is determined and a wood density factor is employed to determine the total log end area. The total volume of the stack is determined by factoring in the standard log length.

In a third embodiment, (truck) one or more stacks or piles of logs on a truck are digitally imaged from the side of the truck, the height of each load is extracted from the digital image, the log length and width of the truck bed is factored together with a density value for determination of the stack volume.

The present invention, for example can be used to measure log stacks, container and trucks (i.e. the parts where you can perpendicularly see the log ends). The present invention enables to provide the proof of timber origin, option to re-measure a processed stack of timber, statistical analysis—how much, what type, what quality timber was received and shipped at a given warehouse location during a defined time period.

In sawmills at receiving timber the present invention helps to understand how much and what kind of diameter has been bought. This is used if they have any claims against the buyer or for their in-house active storage state. By carrying out the inventories the sawmills need to measure the sawmill lot to get an overview of the exact amount of timber that they have. For that the present invention will compare the inventory result with the active storage state. Regarding invoicing the present invention provides the opportunity to add a price to the sortiment. So the pricing calculation is done automatically distinguished by the certain culls, and different assortment.

For the private forest owners, the present invention provides a picture of the log stack that proves and gives an estimate of how much timber they sold. Usually the buyers dictate the amount of timber that they receive.

The picture of the log stack makes the selling process more transparent, helps with theft protection and gives an exact amount of logs and therefore if the log stack stays for a longer period beside the road, then it is easy to re-measure/re-count the logs to see if there have been any theft.

For the forestry commissions and government forestry organizations the present invention supports the process of selling and buying timber—proof with a picture, data will be added to their in-house system where they can analyze, invoice, and sort the timber. Regarding theft protection the present invention also proves of what quantity and quality was present on a certain time period in a certain place.

For the export/import timber companies the present invention helps to measure and count the logs—to export timber the company needs to have an accurate count of the logs and volume. One of the outputs of this is converted weight, other is to avoid claims against the quality of the wood (since the timber is visible on the image). In addition, the present inventions supports the documentation—bill of ladings, container, bill of credit documents consist of the input of timber volume.

With these ends in view, the invention finds embodiment in various combinations of elements, arrangements of parts and series of steps by which the above-mentioned aspects, features and considerations and certain other aspects, features and considerations are attained, or with reference to the accompanying drawings and the scope of which will be more particularly pointed out and indicated in the appended claims.

### BRIEF DESCRIPTION OF THE DRAWINGS

In the accompanying drawings, wherein some of the various possible exemplary embodiments of the invention are shown:

FIG. 1 is a flowchart generally depicting the overall routines in carrying out the present invention;

FIG. 2 is a diagrammatic depiction of a smart device camera employed for digital image acquisition together with superimposed axes for angle sensor correlation;

FIG. 3 is a flowchart depicting the various image analysis routines in accordance with the invention;

FIG. 4 is a schematized illustration of a cluster circle filter procedure;

FIG. 5 is a schematized illustration of an octagon image adjustment filter procedure;

FIG. 6 is a schematized illustration of a pixelwise segmentation adjustment filter procedure;

FIG. 7 is a further illustration of the pixelwise segmentation adjustment filter procedure;

FIG. 8 is a further illustration of the pixelwise segmentation adjustment filter procedure;

FIG. 9 is a depiction of a screen shot of digital image showing manual operator adjustment features of the invention;

FIG. 10 is an overview flow chart depicting a series of routines for timber quantification in accordance with the invention;

FIG. 11 is a flowchart depicting various routines relating to initial processing of digital photographs for log-by-log volume determination in accordance with the invention.

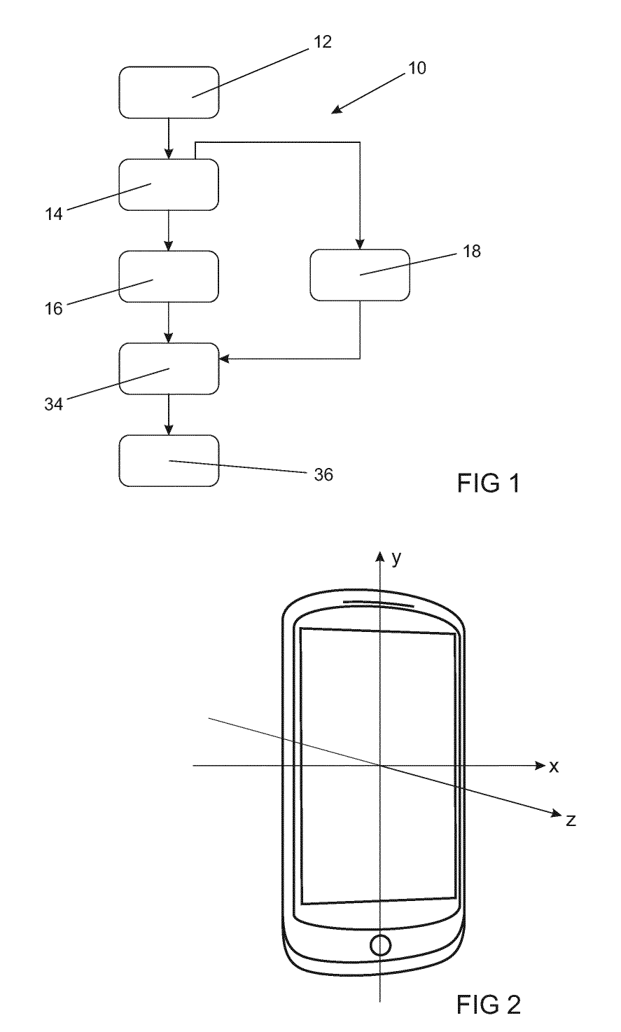

### DETAILED DESCRIPTION OF THE INVENTION

The present invention will now be described in detail with reference to the drawings, which are provided as illustrative examples of the invention so as to enable those skilled in the art to practice the invention.

An image processing apparatus according to the present invention for determining the volume of timber in a stack of logs comprising a hand held smart device, which comprises a camera, an interactive screen, an accelerometer, and an input device for receiving stratification parameters of the stack of logs, wherein the smart device

being programmed to store and display data comprising a digital image of the longitudinal end of a stack of logs and an image of a known reference dimension;

being programmed to filter the digital image for recognition of log ends and to superimpose circles coinciding with and around each log end within the digital image and to determine the volume of timber in the stack as a function of the area within the circles and the stratification parameters;

being programmed to load the digital image including the superimposed circles on the interactive screen, whereby an operator may manually adjust the superimposed circles prior to the determination the stack volume;

being programmed with an angle sensor routine to assure virtual positioning of the camera parallel to the longitudinal end of the stack of logs.

In one embodiment, the method of determining the volume of timber in a stack of logs according to the present invention having stratification parameters with a hand held programmable smart device, which comprises a camera, an accelerometer and an angle sensor routine is employed to assure virtual positioning of the camera parallel to the stack end, the method comprising the steps of:

a) employing the camera to capture a digital image of the log ends together with a known reference dimension along a plane parallel to the log ends,

b) loading the digital image into an interactive screen of the smart device,

c) entering the reference dimension image data through the interactive screen,

d) entering stratification parameters,

e) filtering the digital image to detect and superimpose circles on log ends within the digital image, and manually adjusting the superimposed circles on the interactive screen prior to performing step (f)

f) determining the stack volume as a function of the total areas of the superimposed circles and the stratification parameters.

In an alternative embodiment, the method of determining the volume of timber in a stack of logs according to the present invention having a known log length with a hand held programmable smart device, which comprises a camera, an accelerometer and an angle sensor routine is employed to assure virtual positioning of the camera parallel to the stack end, the method comprising the steps of:

a) employing the camera to capture a digital image of the log ends together with a known reference dimension,

b) loading the digital image into an interactive screen of the smart device,

c) entering the reference dimension image data and the log length data through an input device,

d) filtering the digital image to detect and circle log ends within the digital image, and manually adjusting the circles on the interactive screen prior to performing step (e),

e) determining the stack volume as a function of the total areas of the circles and the log length.

The stratification parameters comprise the length of the logs within the stack, tree species of the logs in the stack, a routine for volume calculation and/or reference dimension data.

Filtering the digital image comprises employing a cascade detector routine and a candidate merge routine, the removal of false detections, the removal of overlapping detections and/or employing a pixelwise segmentation routine for adjustment of detections.

Referring now in detail to the drawings the reference numeral 10 denotes generally the overall system for timber quantification in accordance with the present invention. The system 10 comprises various routines and procedures implemented through a programmable hand held smart device 15 (e.g. mobile phone with a mobile operating system, smartphone, tablet, smart watch, smart glasses, video camera, digital camera) as will be pointed out in detail. Initially, a digital image of a stack of log ends is captured, as indicated in the block 12.

Preferably, the digital image is in color so as to facilitate identification of species, grade, etc. The image is captured with a camera of the smart device 15 (depicted in FIG. 2) from a distance where all log ends of a stack are visible within the frame. The prerequisites for capturing a correct image include a known dimension on the level of the log ends (at least 100 cm) with the camera being parallel towards the end of the stack.

An angle sensor routine is then entered and the smart device accelerometer readings, i.e., pull forces in the direction of the arrows in FIG. 2, are taken along each axis.

Accelerometer readings are normalized by dividing each reading by the square root of the sum of their squares.

norm=sqrt(a*a+b*b+c*c)

a′=a/norm

b′=b/norm

c′=c/norm

The angle along the requested axis is calculated by finding the arctan of the readings from the other two axes. (angle x=atan2(reading y, reading z)).

If the picture produced from the camera is distorted a calibration matrix will be applied to get an accurate measurement.

At this stage the algorithm workflow is started in the background. The operator enters the defining stratification parameters in the interactive screen or an optional keyboard as indicated in a block 14, including the following values:

Log length for calculating each volume of the log.

Reference dimension value (by default 100 cm and cannot be less).

The calculation formula (by default Cylindrical). Any kind of formula that uses the small-end diameter of a log to calculate the volume of logs.

Tree species

Optional parameters can also be entered, such as:

File name can be changed (by default a combination of date and time).

Storage (custom web-application parameters)—which is an entity to which the image (measurement) is connected to.

Measurement type (by default uncategorized). Possible values are Incoming, Outgoing, Inventory, Uncategorized. these values are used to keep the active storage state in the web application.

Quality—dynamic list of different timber qualities. Custom values can be added.

Assortment—dynamic list of objects that have connected timber length, quality, price and species.

Cull by diameter—A min and max diameter is defined to mark logs as cull on the image.

Comment—any kind of text the operator wishes to add as a comment to the measurement.

The operator then enters the reference value (known dimension on the level of the log ends) as indicated in a block 16 on the interactive screen. The operator is prompted to view the taken digital image on an interactive screen. Graphical elements are provided to mark the start and the end of an image or separated points of the known dimension. Marks are dragged by the operator and a line is provided to the start and end center points of the known dimension. Each center point must be at its respective start and end position. While dragging the marks, a zoomed image is illustrated in a preview box in a corner of the screen. Users have the option to zoom in on any location in the image to get the most accurate results.

In an alternative embodiment in the block 16 an automatic image scale appraisal is performed. The purpose of automatic image scale appraisal is to determine the true size of objects in an image captured by a camera. The calculations rely on the following information being available: distance between the camera and object, horizontal and vertical field of view angle, and the image distortion matrix. The distortion matrix is a calibrated set of values used to remove any distortions created by a camera and transform the image to create a true scale 2d model. Before calculating the object true size, camera distortions are removed from the captured image by using the distortion matrix and transformation formulas.

The following formulas are used to assess the vertical and horizontal dimensions of an object in the captured image:

object true width=distance×tan(horizontal field of view angle/2)×object width in pixel/image width in pixels

object true height=distance×tan(vertical field of view angle/2)×object height in pixel/image height in pixels

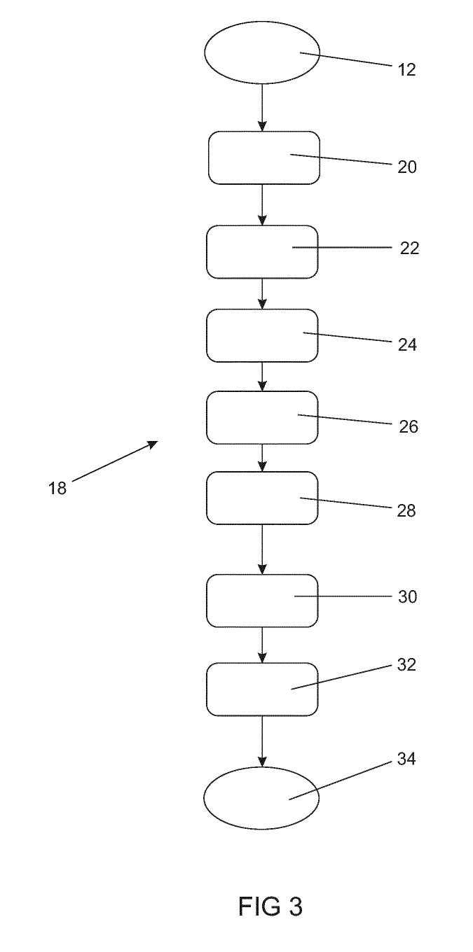

The system 10 then proceeds with detection procedure routines 18 including a cascade detector routine 20 as illustrated in FIG. 3. The cascade detector 20 employs a trained classifier, that is the output of a training process that included about 50 thousand carefully chosen and cut out images of log ends and about 10 thousand of carefully chosen images that have the context of being the background of a log, but none of them have any logs on them (http://docs.opencv.org/2.4/doc/user_guide/ug_traincascade.html), incorporated herein by reference.

The training process is derived from “Learning Multi-scale Block Local Binary Patterns for Face Recognition” (http://www.cbsr.ia.ac.cn/users/lzhang/papers/ICB07/ICB07_Liao.pdf), incorporated herein by reference. Parameters for the training process are optimized for the highest accuracy and detection rate possible.

The trained LBP classifier is then applied to the image of the log stack. A detailed description of this procedure may be found at: http://docs.opencv.org/2.4/modules/objdetect/doc/cascade_classification.html#id2 and http://www.multimedia-computing.de/mediawiki//images/5/52/MRL-TRMay02-revised-Dec02.pdf, which are incorporated herein by reference.

The detected log ends are returned as a list of rectangles. The cascade detector output is then subject to further processing at a candidate merge routine 22, which locates logs that have been detected more than once and creates a single detection. Detections are merged, if they satisfy the following predicate.

A delta is calculated by multiplying a constant with the width of the smaller of the two rectangles. The distance between each corresponding corner of the rectangles must be smaller than or equal to delta. The number of detections that were merged into a single detection is saved as the ‘votes’ that the detection received. Each detection that receives less than const n votes, is removed.

For each merger, the final detection location and size is found by accounting for the location and size of each candidate and the local gradient in the image. Each of the edge of the merged rectangles is calculated separately, with the edge coordinate being the average of each of the candidate's corresponding edge weighted by the gradient of the image at those coordinates. The gradient is found using the Sobel operator (https://en.wikipedia.org/wiki/Sobel_operator), incorporated herein by reference.

A circle is then generated created by taking the center point of the rectangle and using the average of width and height of the rectangle as the diameter.

After the initial detections are gathered, the system enters a votes and radius filter routine 24 to remove any false detections. The votes and radius filter routine is based on the tendency for false detections to be smaller than true ones and be merged from less candidates. If the detection does not satisfy the following formula, it is removed: detection radius>=average r*coef vote

Each vote count has a separate coefficient or no coefficient if the detection has a lot of votes and it is never removed by this algorithm.

In an alternative embodiment a defect and tree species detector is added additionally after pixel segmentation routine 32 to determine the primary defect present of a detected log. This is carried out by a trained neural network classifier (http://dl.acm.org/citation.cfm?id=2654889), that is the output of a training process that included images of logs that were of a predetermined species and had a predetermined defect or no defect. The routine input is a subregion of the image containing the detected log. The subregion is centered on the log and have margins that are of a predefined size relative to the log diameter in pixels. If the subregion is on the edge of the source image, the pixels that are out of bounds are to be replaced by black pixels. Thereafter, the subregion is resized to predetermined dimensions.

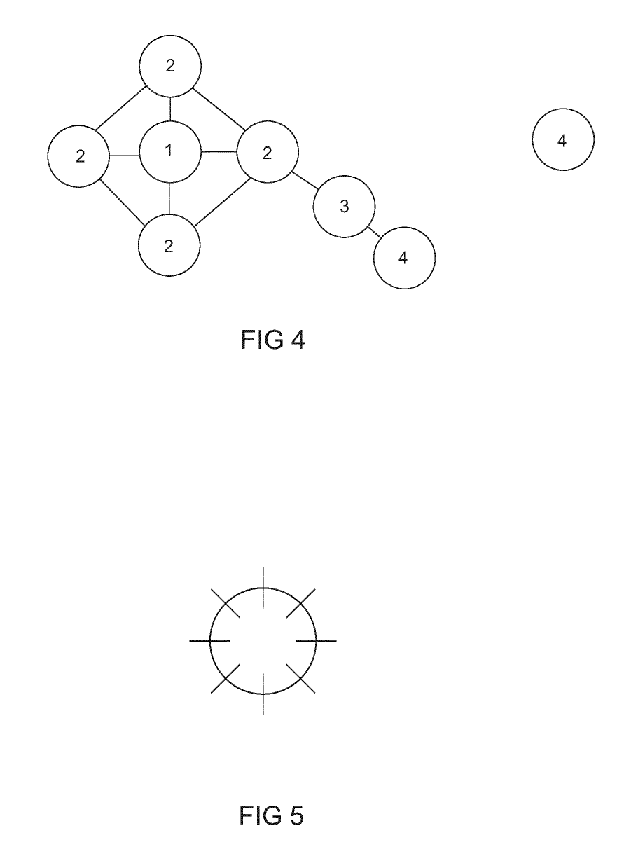

The system then enters a cluster circle filter routine 26 depicted in FIG. 4, wherein the numeral 1 denotes a root circle, the numeral 2 denotes a link circle, the numeral 3 denotes an end circle and the numeral 4 denotes a circle to be eliminated. Every circle has a set of neighbors. The neighbors are found using the following formula: diameter1*coef+diameter2*coef<dist1,2

If a circle has more than const n1 neighbors, it is considered a root circle. Circles that are neighbors to a root circle and have more than const n2 neighbors are considered link circles.

Circles can also be link circles, if they have more than n2 neighbors and are neighboring another link circle. Circles that are neighbors to more than const n3 circles and neighbor a root or link circle, are considered end circles. A circle that has more than n3 neighbors but only neighbors end circles, does not become an end circle. All circles that are not root, link or end circles are eliminated.

The system 10 then enters a concentric filter routine 28 which removes detections which significantly overlap. Overlapping circles are defined using the following formula: rad1*coef+rad2*coef<const

The routine orders all detections by size in descending order. For each detection, all overlapping detections are found (these detections are small and inside the original detection, because of the ordering). The goal is to do one of the following: remove the larger detection or all of the detections that it contains.

A weight is calculated for each of the detections in consideration. The weight is calculated using the detection votes (calculated in the candidate merge routine 22), the detection size and the average size of all detections. The following formula is used: votes* (min(average r, detection r)/max(average r, detection r))̂ const×detectionr̂ const

If the weight of the original detection is larger than the sum of the weights of the overlapping detections, the original detection is removed. Otherwise all the detections it overlapped with are removed.

At this point all filters are applied and the exact log end area determination is initiated.

The system then enters the octagon routine 30 which adjusts detections to be closer to the true log. As illustrated in FIG. 5, the system considers points along straight lines drawn near and perpendicular to the circumference of each circular detection, with a 45 degree angle between each line. The point at the highest contrast location is chosen for each of the eight lines.

For each of the found points, if the contrast is lower than a constant, it is discarded, and replaced with the point where the drawn line and circumference of the detection cross. A new detection is created, using the average coordinates of all the selected points as its center and the distance of each point from their average as the radius.

Thereafter, the system enters a pixelwise segmentation routine 32, which adjusts detections to be closer to the true log. A subsample of the image around each detection, is taken creating a labelling for every pixel in the subsample and running an image segmentation method, for example GrabCut algorithm. The subsample is a square which has the same center as the detection and whose width and height are the detection diameter multiplied by a coefficient.

Every pixel in the subsample must have one of four labels: certain foreground, certain background, probable foreground, probable background. Each of them is drawn as a region of a distance range from the center of the rectangle. Ordered ascendingly by the distance, they are certain foreground, probable foreground, probable background, certain background. The distance ranges are relative to the radius of the detection.

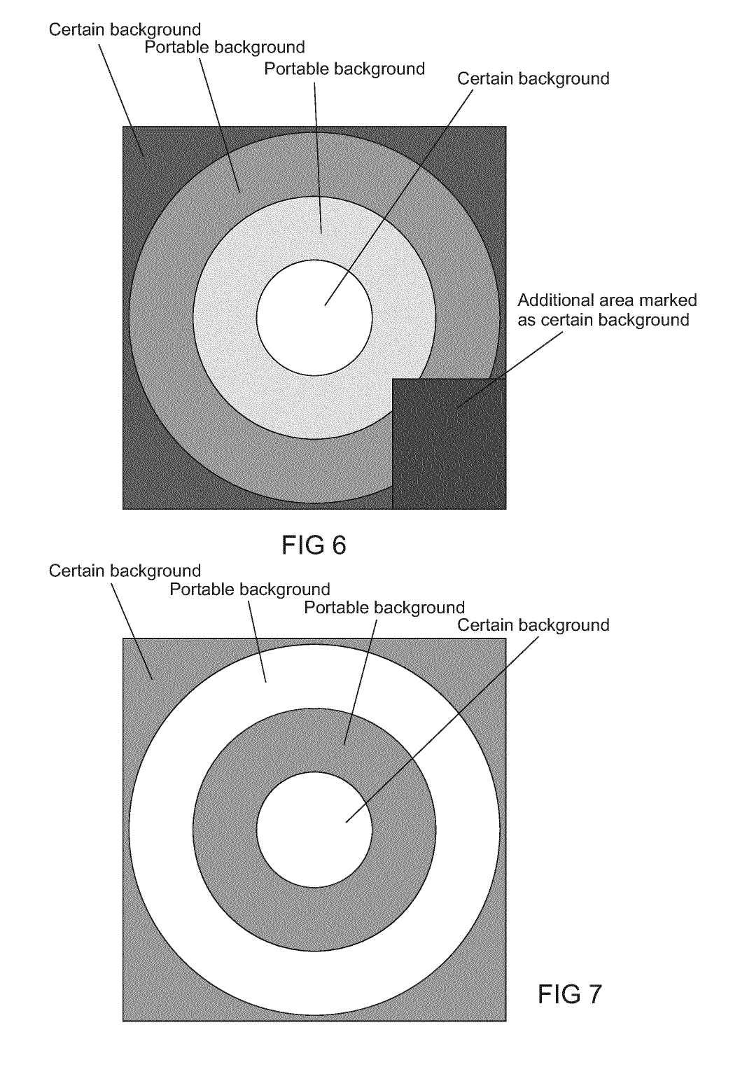

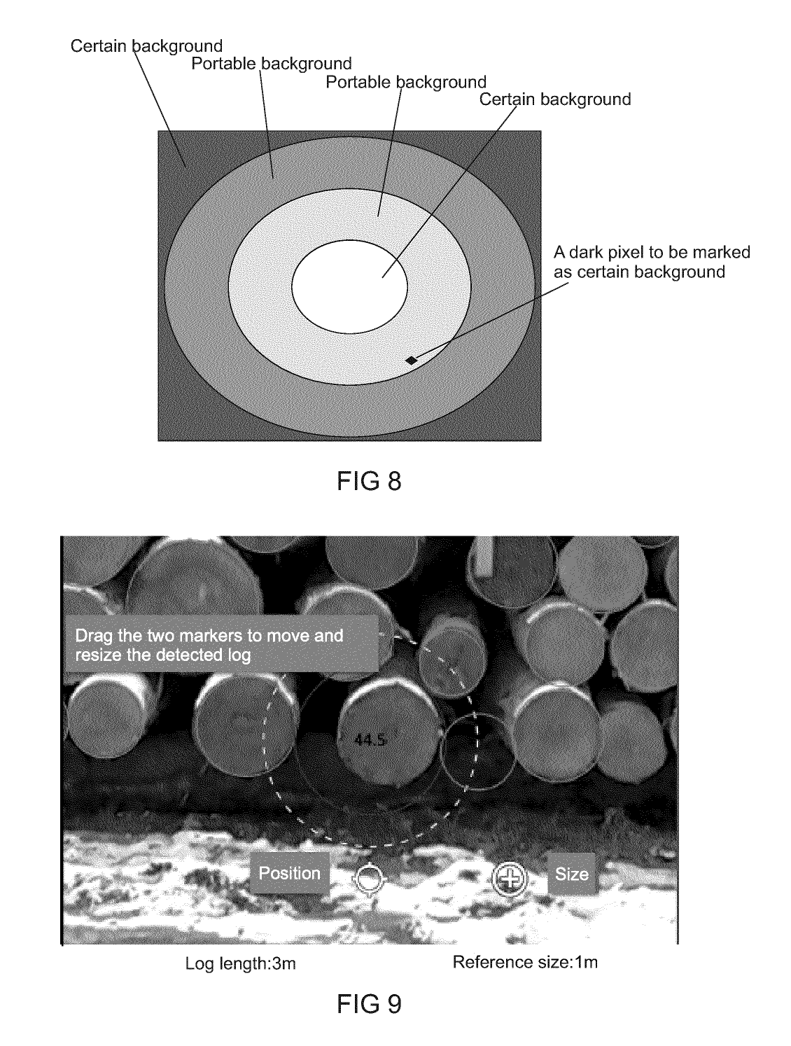

This is followed by a routine which may set additional pixels as certain background, as shown in FIG. 6. A histogram of grayscale pixel values is created using pixels that are no more than detection radius times const distance away from the detection center. A value is chosen, which represents the brightness of which const p per cent of pixels in the center area are darker, and 100-p per cent of pixels are lighter. For each pixel labelled probable foreground or probable background, if its grayscale value is lower than the brightness chosen in the previous step, the pixel is marked as certain background. In addition, all pixels in the same quadrant of the image, which are even farther away from the image center along both x and y axes, are marked as certain background, as shown in FIG. 6.

Image segmentation method, for example GrabCut, is performed using the constructed labels. This will create a new labelling, where certain foreground and probable foreground mark the log area. Open cv moments algorithm is used to convert the labelling into a circle which has the same area and center as the foreground area.

After the detection procedure routines 18 completes its workflow, a set of circles is drawn to the image on the interactive screen, with each circle representing a log end on the image, as illustrated in FIG. 9.

The operator may then “fine-tune” the circles on the interactive screen, as indicated in a block 34. Each circle can be made active by taping on it; each circle's position can be changed by dragging the position icon and each circle's size can be changed by dragging a size slider horizontally. The operator can initiate a detection process in a location where the circle has been omitted (by holding one's finger down on the spot lacking a circle); false logs can be deleted by holding one's finger down within the circle. The operator can also set the circle to be cull, or assign a different assortment to it.

After the operator has validated the circles, the measurements are saved, all of data is uploaded to a server and the images are uploaded to the cloud, as indicated in a block 36. All measurements are stored in the smart device and in a web application in a digital image form wherein the circles superimposed on each of the log ends are visible.

Thus it will be seen that there is provided a system for timber quantification which achieves the various aspects, features and considerations of the present invention and which is well suited to meet the conditions of practical use. All publications and references cited herein are expressly incorporated herein by reference in their entirety.

In the figures of this application, in some instances, a plurality of elements may be shown as illustrative of a particular element, and a single element may be shown as illustrative of a plurality of a particular elements. Showing a plurality of a particular element is not intended to imply that a system or method implemented in accordance with the invention must comprise more than one of that element or step, nor is it intended by illustrating a single element that the invention is limited to embodiments having only a single one of that respective element. Those skilled in the art will recognize that the numbers of a particular element shown in a drawing can, in at least some instances, be selected to accommodate the particular user needs.

The particular combinations of elements and features in the above-detailed embodiments are exemplary only; the interchanging and substitution of these teachings with other teachings in this and the incorporated-by-reference patents and applications are also expressly contemplated.

As those skilled in the art will recognize, variations, modifications, and other implementations of what is described herein can occur to those of ordinary skill in the art without departing from the spirit and the scope of the invention as claimed.

Having described the preferred embodiments of the invention, it will now become apparent to one of ordinary skill in the art that other embodiments incorporating their concepts may be used. Moreover, those of ordinary skill in the art will appreciate that the embodiments of the invention described herein can be modified to accommodate and/or comply with changes and improvements in the applicable technology and standards referred to herein. For example, the technology can be implemented in many other, different, forms, and in many different environments, and the technology disclosed herein can be used in combination with other technologies. Variations, modifications, and other implementations of what is described herein can occur to those of ordinary skill in the art without departing from the spirit and the scope of the invention as claimed. It is felt therefore that these embodiments should not be limited to disclosed embodiments but rather should be limited only by the spirit and scope of the appended claims.

The particular combinations of elements and features in the above-detailed embodiments are exemplary only; the interchanging and substitution of these teachings with other teachings in this and the referenced patents/applications are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto.

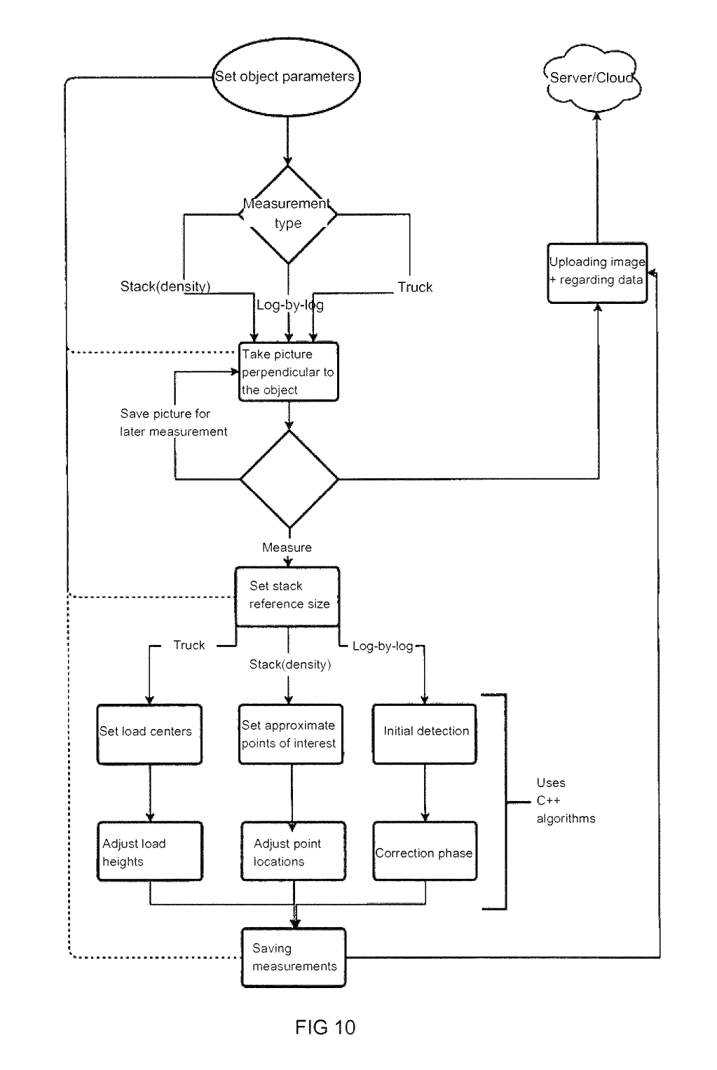

FIG. 10 is an overview flow chart depicting a series of routines for timber quantification in accordance with the invention. Pursuant to the instant invention a digital image of a stack or pile of logs is captured with a camera oriented in a vertical plane and the lens axis horizontal. The captured image includes a reference object having a known dimension.

Referring now to FIG. 10 wherein an overview of the system for timber quantification is depicted, one may initially set the object parameters, i.e., reference dimension, grade/species of the logs in the stack or pile and, if necessary, a density factor based upon visual observation as well as the truck bed width, if appropriate.

A determination is then made as to which type of measurement is to be employed, i.e., periphery, log-by log or truck. The digital image is then taken and the reference dimension is then input.

In the event the truck measurement image is taken, a load center is set for each stack of logs on the truck, the load height is determined, a load volume measurement is made after factoring the reference dimension, density factor, truck bed width and standardized length.

In the event the digital image is employed for peripheral measurement of a stack, points along the periphery of the stack are set in the digital image, the points are adjusted and then joined to form a peripheral border for calculation of the total area within the border after factoring the reference dimension. The volume is determined after factoring the density factor and standardized log length.

In the event the digital image is employed for log-by-log measurement, the system detects the end of each log in the stack and overlies circles coincident with each detected log end. The circles are then adjusted to conform to the actual log end images and calculation of the area of each circle. The total volume is determined after factoring in the standardized log length.

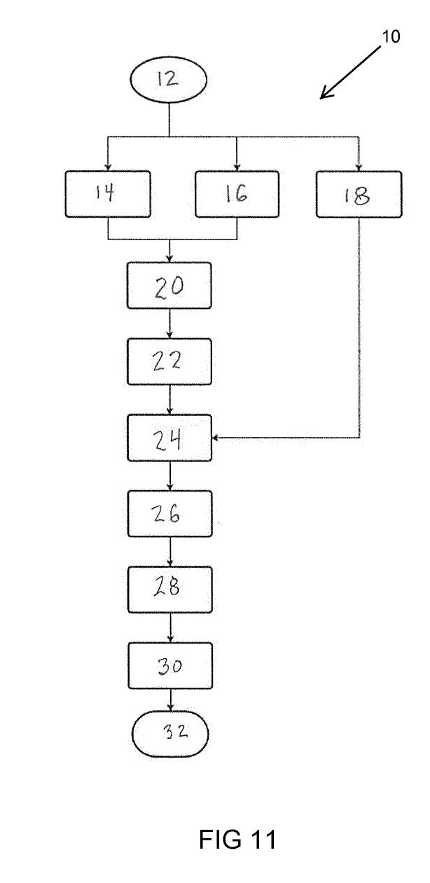

FIG. 11 is a flowchart depicting various routines relating to initial processing of digital photographs for log-by-log volume determination in accordance with the invention. The digital image is captured and filtered in accordance with the routine 10, depicted in FIG. 11. As illustrated in FIG. 11, initially, a digital image of the end of ted stack is taken as indicated at 12. The camera preferably takes a color image with the lens axis horizontal, i.e., parallel to the axes of the logs. The image includes an object having a known dimension.

Thereafter the digital image is analyzed with three log detection routines, a histogram oriented gradient detection routine, (Greedy Hog Detect) 14, a local binary patterns detection routine (Greedy LBP Detect) 16 and a strict local binary patterns routine (Strict LBP Detect) 18.

The outputs of the histogram oriented gradient detection routine 14 and the local binary patterns detection routine 16 are input to a union routine 20 which eliminates duplicates based upon location and size.

The output of the union routine 20 is input to a cluster filter routine 22 which removes probable false detections based upon the assumption that true logs are clustered close together and detections which are remote from the cluster are probably false detections. The strict local binary patterns routine 18 analyzes the color of the log ends and generates a baseline of target color value which is received at and HSV filter routine 24 along with the output of the cluster filter routine 22. The HSV filter routine removes from the output of the cluster filter routine 22 log detections which differ significantly from the baseline or target color value.

Thereafter the system proceeds to an exclusion filter routine 26 which detects and excludes detections which coincide. The system then proceeds to a second cluster filter routine 28 which removes probable false detections based upon the assumption that true logs are clustered close together and detections which are remote from the cluster are probably false detections.

A grabcut routine 30, is then employed to refine the exact size and location of each log end in the digital image. The total areas 32 of all log ends in the stack is then employed to determine the stack volume.

The total area of the log ends in the stack and the standard log length may then be input to standard formulas for determination of the total stack volume. Among the standard formulas are the Nilson (Estonian), GOST (Russian), JAS (Japanese Agricultural standard) and Cylindrical.

1. A method of determining the volume of timber in a stack of logs having stratification parameters with a hand held programmable smart device having a camera, the method comprising the steps of:
a) employing the camera to capture a digital image of the log ends together with a known reference dimension along a plane parallel to the log ends,
b) loading the digital image into an interactive screen of the smart device,
c) entering the reference dimension image data through the interactive screen,
d) entering stratification parameters,
e) filtering the digital image to detect and superimpose circles on log ends within the digital image, and
f) determining the stack volume as a function of the total areas of the superimposed circles and the stratification parameters.

2. The method of determining the volume of timber in a stack of logs in accordance with claim 1 wherein the smart device comprises an accelerometer and an angle sensor routine is employed to assure virtual positioning of the camera parallel to the stack end.

3. The method of determining the volume of timber in a stack of logs in accordance with claim 1 further comprising the step of manually adjusting the superimposed circles on the interactive screen prior to performing step (f).

4. The method of determining the volume of timber in a stack of logs in accordance with claim 1 wherein the stratification parameters comprise the length of the logs.

5. The method of determining the volume of timber in a stack of logs in accordance with claim 1 wherein the stratification parameters comprise a routine for volume calculation.

6. The method of determining the volume of timber in a stack of logs in accordance with claim 1 wherein step (e) comprises employing a cascade detector routine and a candidate merge routine.

7. The method of determining the volume of timber in a stack of logs in accordance with claim 1 wherein step (e) further comprises the removal of false detections.

8. An image processing apparatus for determining the volume of timber in a stack of logs comprising a hand held smart device having a camera, the smart device being programmed to store and display data comprising a digital image of the longitudinal end of a stack of logs and an image of a known reference dimension, an input device for receiving stratification parameters of the stack of logs, the smart device being programmed to filter the digital image for recognition of log ends and to superimpose circles coinciding with and around each log end within the digital image and to determine the volume of timber in the stack as a function of the area within the circles and the stratification parameters.

9. The image processing apparatus in accordance with claim 8 wherein the stratification parameters comprise the length of the logs within the stack.

10. The image processing apparatus in accordance with claim 8 wherein the stratification parameters comprise tree species of the logs in the stack.

11. The image processing apparatus in accordance with claim 8 wherein the smart device comprises an interactive screen, the smart device being programmed to load the digital image including the superimposed circles on the interactive screen, whereby an operator may manually adjust the superimposed circles prior to the determination the stack volume.

12. The image processing apparatus in accordance with claim 9 wherein the stratification parameters comprise a routine for volume calculation.

13. The image processing apparatus in accordance with claim 8 wherein the stratification parameters comprise reference dimension data.

14. The image processing apparatus in accordance with claim 8 wherein the smart device comprises an accelerometer, the smart device being programmed with an angle sensor routine to assure virtual positioning of the camera parallel to the longitudinal end of the stack of logs.

15. The method of determining the volume of timber in a stack of logs in accordance with claim 1 wherein step (e) comprises the removal of overlapping detections.

16. The method of determining the volume of timber in a stack of logs in accordance with claim 1 wherein step (e) comprises employing a pixelwise segmentation routine for adjustment of detections.

17. A method of determining the volume of timber in a stack of logs having a known log length with a hand held programmable smart device having a camera, the method comprising the steps of:
a) employing the camera to capture a digital image of the log ends together with a known reference dimension,
b) loading the digital image into an interactive screen of the smart device,
c) entering the reference dimension image data and the log length data through an input device,
d) filtering the digital image to detect and circle log ends within the digital image, and
e) determining the stack volume as a function of the total areas of the circles and the log length.

18. The method of determining the volume of timber in a stack of logs in accordance with claim 17 further comprising the step of manually adjusting the circles on the interactive screen prior to performing step (e).

19. The method of determining the volume of timber in a stack of logs in accordance with claim 17 wherein the camera is positioned parallel to the log ends when performing step (a).

20. The method of determining the volume of timber in a stack of logs in accordance with claim 19 wherein the smart device comprises an accelerometer and an angle sensor routine is employed to assure virtual positioning of the camera parallel to the stack end.
